(19) United States
(12) Patent Application Publication
(10) Pub. No.: US 2017/0288947 A1
(43) Pub. Date: Oct. 5, 2017

(54) RESTORING A FLOW PATH IN RESPONSE TO A LINK FAILURE IN A SOFTWARE DEFINED NETWORK (SDN)

(71) Applicant: HEWLETT PACKARD ENTERPRISE DEVELOPMENT LP, Houston, TX (US)

(72) Inventors: Celestian KANIAMPADY SEBASTIAN, Bangalore (IN); Anil RAJ, Bangalore (IN); Vijeesh ERANKOTTE PANAYAMTHATTA, Bangalore (IN); Prasanth GOPINATHAN NAIR SARASWATHYAMMA, Bangalore (IN)

(21) Appl. No.: 15/507,529

(22) PCT Filed: May 4, 2015
(86) PCT No.: PCT/US2015/029066

§ 371 Date: Feb. 28, 2017

(30) Foreign Application Priority Data
Mar. 13, 2015 (IN) 1254/CHE/2015

(51) Int. Cl. H04L 12/24; H04L 12/707

(52) U.S. Cl. CPC H04L 41/0654; H04L 45/22

(57) ABSTRACT

Examples disclosed herein relate to restoring a flow path in response to a link failure in a software defined network (SDN). In an example, a backup flow path for a flow may be configured in a network device, on a primary flow path of the flow. In response to determination of a link failure in the primary flow path, the network device configured with the backup flow path may be identified. In an example, the network device may be identified by sending, from a detecting network device that detects the link failure on the primary flow path, a message packet successively to each network device preceding the detecting network device on the primary flow path until the network device configured with the backup flow path is identified. The backup flow path may be used to route packets of the flow.

### BACKGROUND

A software defined network (SDN) is based on a network architecture that decouples the control plane from the data plane. The control plane is implemented in an SDN controller and the data plane is implemented in the networking infrastructure (e.g., switches and routers). In SDN, data forwarding on a network device is controlled through flow table entries populated by the SDN controller that manages the control plane for that network. A network device that receives packets on its interfaces looks up its flow table to check the actions that need to be taken on a received packet.

### BRIEF DESCRIPTION OF THE DRAWINGS

For a better understanding of the solution, embodiments will now be described, purely by way of example, with reference to the accompanying drawings, in which:

FIG. 1 is a block diagram of an example system for restoring a flow path in response to a link failure in a software defined network (SDN);

FIG. 2 is a diagram of an example network system for restoring a flow path in response to a link failure in a software defined network (SDN);

FIG. 3 is a block diagram of an example method for restoring a flow path in response to a link failure in a software defined network (SDN); and

FIG. 4 is a block diagram of an example system for restoring a flow path in response to a link failure in a software defined network (SDN).

### DETAILED DESCRIPTION

Software defined networking (SDN) is an approach to networking in which control is decoupled from networking equipment and given to a device called a controller (or SDN controller). The controller is aware of all the devices and their points of interconnection in a SDN network and may perform various functions such as routing, policy implementation, receiving unknown flow packets, path resolution, flow programming, etc. Each new or missed flow through the network is routed via the controller that decides the network path for a flow and adds an entry for that flow in a flow table, in each of the network devices along the path. A SDN enabled device consults a flow table(s) for forwarding packets in the data plane. Each forwarding rule (flow entry) includes an action that dictates how traffic that matches the rule is to be handled. Switches also apprise controller about any link status change in the network (for example, a link is up or down). In response, the controller may reprogram a flow(s) to accommodate those changes. Thus, it is necessary to maintain constant network connectivity between a switch and a controller.

However, there may be a scenario where a controller may become unavailable in a software defined network. For example, a controller may fail. In another instance, there may be loss in connectivity to a controller. In such cases of controller unavailability, a network link down event in a SDN network may not be acted upon, and switches may start dropping packets, especially new packets for which no programmed rule may be available. Needless to say, this is not desirable scenario.

To address such issues, the present disclosure describes various examples for restoring a flow path in response to a link failure in a software defined network (SDN). In an example, a backup flow path may be configured for a flow, in a network device on a primary flow path of the flow. In response to determining a link failure in the primary flow path, the network device configured with the backup flow path may be identified. In an instance, the network device may be identified by sending, from a detecting network device that detects the link failure on the primary flow path, a message packet successively to each network device preceding the detecting network device on the primary flow path until the network device configured with the backup flow path is identified. The backup flow path may then be used to route packets of the flow. The proposed solution helps identify an alternate flow path for a flow when a network link is down and the controller is unavailable to program a new path for the flow.

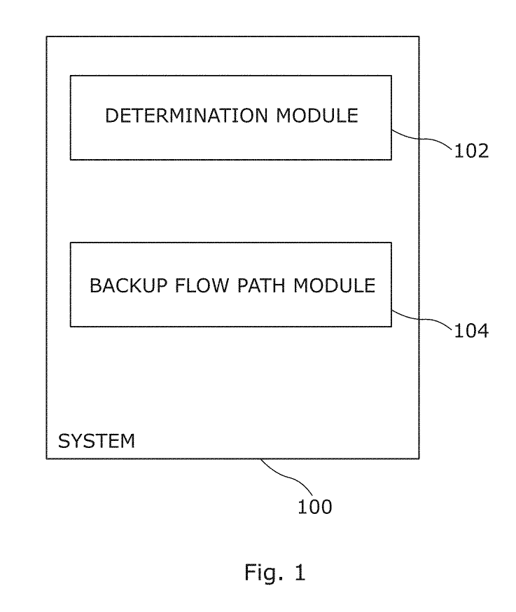

FIG. 1 is a block diagram of an example system for restoring a flow path in response to a link failure in a software defined network (SDN). In an example, system 100 may represent any type of computing system capable of reading machine-executable instructions. Examples of computing device 100 may include, without limitation, a server, a desktop computer, a notebook computer, a tablet computer, a thin client, a mobile device, a personal digital assistant (PDA), a phablet, and the like.

In another example, system 100 may be a network device such as, but not limited to, a network switch, a network router, a virtual switch, and a virtual router. In a further example, system 100 may be an SDN enabled device or an Open-Flow enabled device. In a yet another example, system 100 may be a computer application (machine-executable instructions).

In the example of FIG. 1, system 100 may include a determination module 102 and a backup flow path module 104. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a system (e.g. 100).

Determination module 102 may determine the status of a network link in a software defined network (SDN). In other words, determination module 102 may determine whether a network link in a SDN is up or down. In an instance, the determination module 102 may determine if there's a link failure in a primary flow path of a flow in a SDN. The primary flow path of a flow may be defined to include a flow path which is originally defined for a flow by an SDN controller. In other words, when a new data flow begins, an SDN controller may identify an end-to-end path for the flow, and install the flow entries in each of the network devices that may participate in the flow. The primary flow path of a flow may pass through one or more network devices in a SDN before it reaches a destination device (for example, a server).

Determination module 102 may also determine the availability of a controller in a SDN. In other words, the determination module 102 may determine whether a controller is available to facilitate route packets of a flow in the SDN. In other words, whether a controller is present to program a flow entry for a flow in a SDN. In an instance, the determination may include determining whether a controller is operational or not (i.e. whether a controller has failed). In another instance, the determination may include determining whether network connectivity between a network device, which may be present, for example, on a primary path of a flow, and a controller is available.

Backup flow path module 104 may identify a network device configured with an alternate flow path for a flow. An SDN controller may configure one or more alternate flow paths for a flow, in one or more network devices of an SDN network. In an instance, one or more of the configured network devices may be present on the primary path of a flow. An alternate flow path of a flow may be used to route data traffic of the flow in a SDN. For instance, in the event the primary flow path of a flow is unavailable. In an example, an SDN controller may assign a priority to each of a plurality of alternate flow paths that may be configured in a network device. The prioritization may be used to determine which of the configured alternate flow paths may be used to route network traffic of a flow, if the primary flow path of the flow is unavailable.

In an example, the backup flow path module 104 may identify a network device configured with an alternate flow path for a flow, in response to a determination (for example, by determination module) that there's a link failure in the primary flow path of the flow. The network device may be identified by sending, from a detecting network device that detects the link failure in the primary flow path of the flow, a message packet successively to each preceding network device on the primary flow path until a network device configured with an alternate flow path is identified. In other words, the message may be first sent to the immediate preceding network device (i.e. network device preceding the detecting network device) on the primary flow path of a flow. If an alternate flow path(s) for the flow is identified on the immediate preceding network device, the message packet may not be sent to another successive preceding network device on the primary flow path of the flow. If no alternate flow path(s) for the flow is identified on the immediate preceding network device, the message packet may be sent successively to each preceding network device on the primary flow path of the flow until a network device configured with an alternate flow path is identified.

The message packet may include information related to identity of the flow. The message packet may also include details related to a link failure in the primary path. In an example, the message may be a cookie, which may be specific to a flow. In other words, each flow in a SDN may be assigned a cookie, which may be identified through a unique cookie ID. In an example, if a link failure is identified in the primary flow path of a flow, the cookie corresponding to the flow may be sent successively to each preceding network device on the primary flow path until a network device configured with an alternate flow path for the flow is identified.

Once a network device configured with an alternate flow path for a flow is identified on the primary flow path of a flow, the backup flow path module 104 may use the alternate flow path to route packets of the flow, from the network device. In case a plurality of alternate flow paths are identified in the network device, the backup flow path module may determine the priority assigned to each of the alternate flow paths. The backup flow path module 104 may then select, in an example, an alternate flow path with highest priority and determine whether the selected path is available to route packets of the flow. If the selected path is available, the backup flow path module 104 may use the selected path to route packets of the flow. In the event, the alternate flow path with highest priority is unavailable (for instance, a link on the path may down), the backup flow path module 104 may evaluate, based on successively decreasing priority, other alternate flow paths in the network device to identify an available alternate flow path for the flow. The backup flow path module 104 may then use the selected path to route packets of the flow.

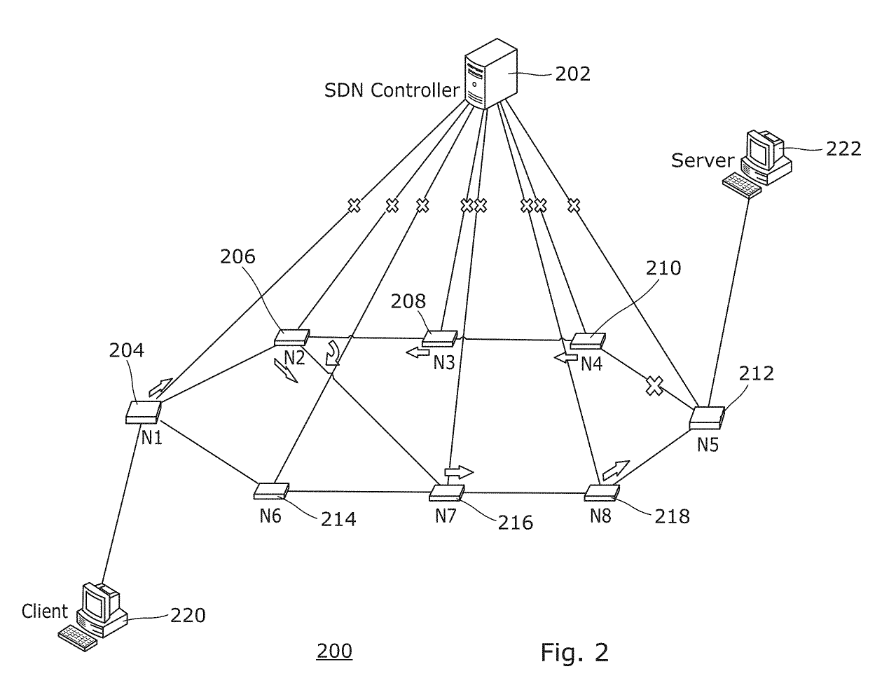

FIG. 2 is a diagram of an example network system 200 for restoring a flow path in response to a link failure in a software defined network (SDN). Network system 200 may include an SDN controller 202, a plurality of network devices N1 (204), N2 (206), N3 (208), N4 (210), N5 (212), N6 (214), N7 (216), and N8 (218), a client computer system (or a source device) 220, and a server (or a destination device) 222. Although only one SDN controller 202, one client computer system, one server, and eight network devices are shown in FIG. 2, other examples of this disclosure may include more than one SDN controller, one client computer system, one server, and more or less number of network devices. In an example, client computer system 220 and server 222 may be the source and destination of an example packet flow(s) in the network system 200, respectively. In an example, network system 200 may be based on software-defined networking (SDN) architecture.

SDN controller 202 may be any server, computing device, or the like. In an example, SDN controller 202 may be a computer application (machine-executable instructions). SDN controller 202 may define the data flow that occurs in network system 200. In other words, SDN controller 202 may determine how packets should flow through the network devices 204, 206, 208, 210, 212, 214, 216, and 218 of network system 200. SDN controller 202 may communicate with network devices 204, 206, 208, 210, 212, 214, 216, and 218 via a standardized protocol (example, OpenFlow) or a suitable API.

SDN controller 202 may communicate with the client computer system 220, server 222, and network devices 204, 206, 208, 210, 212, 214, 216, and 218 over a computer network. Computer network may be a wireless or wired network. Computer network may include, for example, a Local Area Network (LAN), a Wireless Local Area Network (WAN), a Metropolitan Area Network (MAN), a Storage Area Network (SAN), a Campus Area Network (CAN), or the like. Further, computer network may be a public network (for example, the Internet) or a private network (for example, an intranet).

Network devices 204, 206, 208, 210, 212, 214, 216, and 218 may each be, for example, a network switch, a network router, a virtual switch, and a virtual router. In an example, network devices 204, 206, 208, 210, 212, 214, 216, and 218 may each be an SDN enabled device or an Open-Flow enabled device. Network devices may each include one or more flow tables (not shown). Each flow table in network devices 204, 206, 208, 210, 212, 214, 216, and 218 may contain a flow entry (or flow entries). SDN controller 202 may add, update, and delete flow entries in flow tables both reactively (in response to packets) and proactively. Network devices 204, 206, 208, 210, 212, 214, 216, and 218 may each communicate with SDN controller 202 via a standardized protocol such as Open Flow. Network devices 204, 206, 208, 210, 212, 214, 216, and 218 may each accept directions from SDN controller 202 to change values in a flow table.

A flow table matches an incoming packet to a particular flow and specifies the function that may be performed on the packet. If a flow entry matching with a flow is found in a flow table, instructions associated with the specific flow entry may be executed. A packet matches a flow table entry if the values in the packet match fields used for the lookup match those defined in the flow table entry. If no match is found in a flow table (such cases may be termed as “flow table misses”), and the flow may be termed as an “unknown flow”. In such case, in an example, the packet may be forwarded to SDN controller 202.

In an example, network devices 204, 206, 208, 210, 212, 214, 216, and 218 may each be analogous to system 100, in which like reference numerals correspond to the same or similar, though perhaps not identical, components. For the sake of brevity, components or reference numerals of FIG. 2 having a same or similarly described function in FIG. 1 are not being described in detail in connection with FIG. 2. Said components or reference numerals may be considered alike. Network devices 204, 206, 208, 210, 212, 214, 216, and 218 may each include a determination module and a backup flow path module. In an example, aforementioned modules may perform functionalities similar to those described for determination module and backup flow path module of FIG. 1, respectively.

In an example, client computer system may begin communicating with server by sending a packet(s). The first packet(s) may be received by network device 204, which may search for a flow entry corresponding to the received packet(s) in an internal flow table. Since the client computer system is communicating with the server for the first time, there may not be a matching flow entry in the internal flow table. In such case, in an example, the network device N1 204 may forward the packet to the SDN controller. SDN controller may determine how the packet may be handled, and may decide a flow path for the packet in the SDN. In other words, SDN may configure a flow entry in each of the network devices in the flow path that may be used to route the packet to its destination server. This flow path may be called the primary flow path of the flow. In FIG. 2, an example primary flow path may be configured as N1 (204)->N2 (206)->N3 (208)->N4 (210)->N5 (212)->Server (222). In an example, the SDN controller may configure an alternate flow path in network device N2 (206) that may route the flow from N2 (206)->N6 (214)->N7 (216)->N8 (218)->Server (222). Likewise, the SDN controller may configure an alternate flow path in network device N1 (204) that may route the flow from N1 (204)->N6 (214)->N7 (216)->N8 (218)->Server (222).

Let's consider an example scenario wherein the link between network device N4 and N5 goes down. A determination module in network device N4, which acts as a “detecting network device”, may recognize the link failure and determine if the link failure impacts a primary flow path of a flow in the network system. In the present example, a link failure between N4 and N5 may impact the primary flow path of a flow from N1 (204)->N2 (206)->N3 (208)->N4 (210)->N5 (212)->Server. Determination module may also determine whether a controller is available to program a flow entry for the impacted flow. In the event of a link failure and the unavailability of a controller (due to various reasons), a backup flow path module in N4 may identify a network device configured with an alternate flow path for the affected flow. The network device may be identified by sending a message packet successively to each preceding network device on the primary flow path until a network device configured with an alternate flow path is identified. In other words, the message may be first sent to the immediate preceding network device (i.e. N3, in the present example) on the primary flow path of a flow. If an alternate flow path(s) for the flow is identified on the immediate preceding network device (i.e. N3), the message packet may not be sent to another successive preceding network device on the primary flow path of the flow. If no alternate flow path(s) for the flow is identified on the immediate preceding network device N3, the message packet may be sent successively to each preceding network device (i.e. N2 and N1) on the primary flow path of the flow until a network device configured with an alternate flow path is identified. In the present example, SDN controller had configured an alternate flow path in network device N2 (206), before it became unavailable, to route the flow from N2 (206)->N6 (214)->N7 (216)->N8 (218)->Server (222). The backup flow path module may identify N2 as the first network device configured with an alternate flow path for the flow, and determine if the alternate flow path from N2 is available to route the traffic. If the alternate flow path is available, backup path module may use the flow path N2 (206)->N6 (214)->N7 (216)->N8 (218)->Server (222) to route packets of the flow to server 222. In an instance, in such case, the primary flow path of the flow i.e. N1 (204)->N2 (206)->N3 (208)->N4 (210)->N5 (212)->Server may be disabled.

In the event, the alternate flow path from N2 is unavailable to route the traffic (due to various reasons), backup path module may send the message packet successively to each network device preceding N2 on the primary flow to identify another network device configured with an alternate flow path of the flow. In the present example, SDN configured had configured alternate flow path in network device N1 (204), before it became unavailable, to route the flow from N1 (204)->N6 (214)->N7 (216)->N8 (218)->Server (222). The backup path module may identify N1 as network device configured with an alternate flow path for the flow, and determine if the alternate flow path from N1 is available to route the traffic. If the alternate flow path is available, backup path module may use the flow path from N1 (204)->N6 (214)->N7 (216)->N8 (218)->Server (222) to route packets of the flow to server 222. In an instance, in such case, the primary flow path of the flow i.e. N1 (204)->N2 (206)->N3 (208)->N4 (210)->N5 (212)->Server and the alternate flow path of the flow i.e. N2 (206)->N6 (214)->N7 (216)->N8 (218)->Server (222) may be disabled.

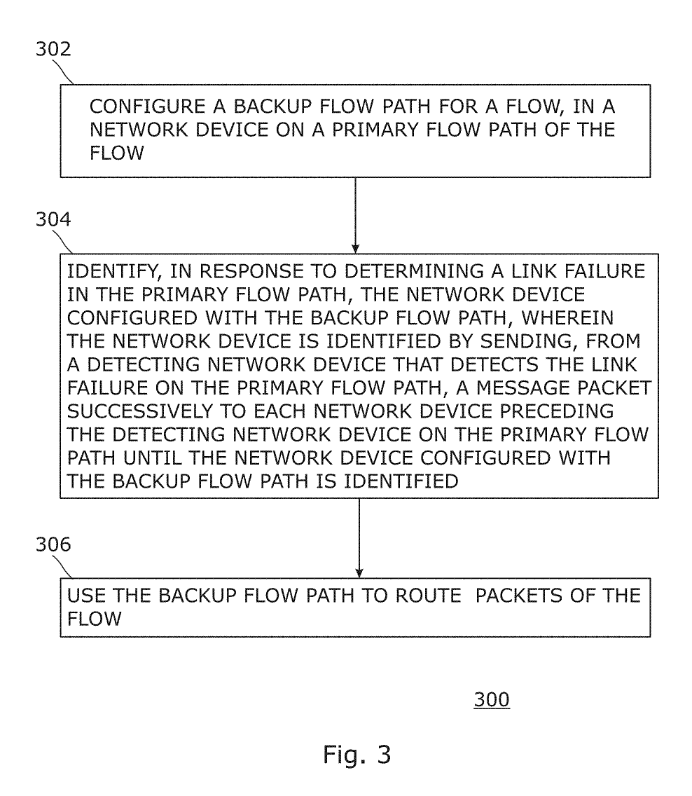

FIG. 3 is a block diagram of an example method 300 for restoring a flow path in response to a link failure in a software defined network (SDN). The method 300, which is described below, may be partially executed on a computing device such as system of FIG. 1 or SDN controller 202 and network devices 204, 206, 208, 210, 212, 214, 216, and 218 of FIG. 2. However, other suitable computing devices may execute method 300 as well. At block 302, a backup flow path for a flow may be configured in a network device on a primary flow path of the flow. At block 304, in response to determining a link failure in the primary flow path, the network device configured with the backup flow path may be identified. In an example, the network device may be identified by sending, from a detecting network device that detects the link failure on the primary flow path, a message packet successively to each network device preceding the detecting network device on the primary flow path until the network device configured with the backup flow path is identified. At block 306, the backup flow path may be used to route packets of the flow.

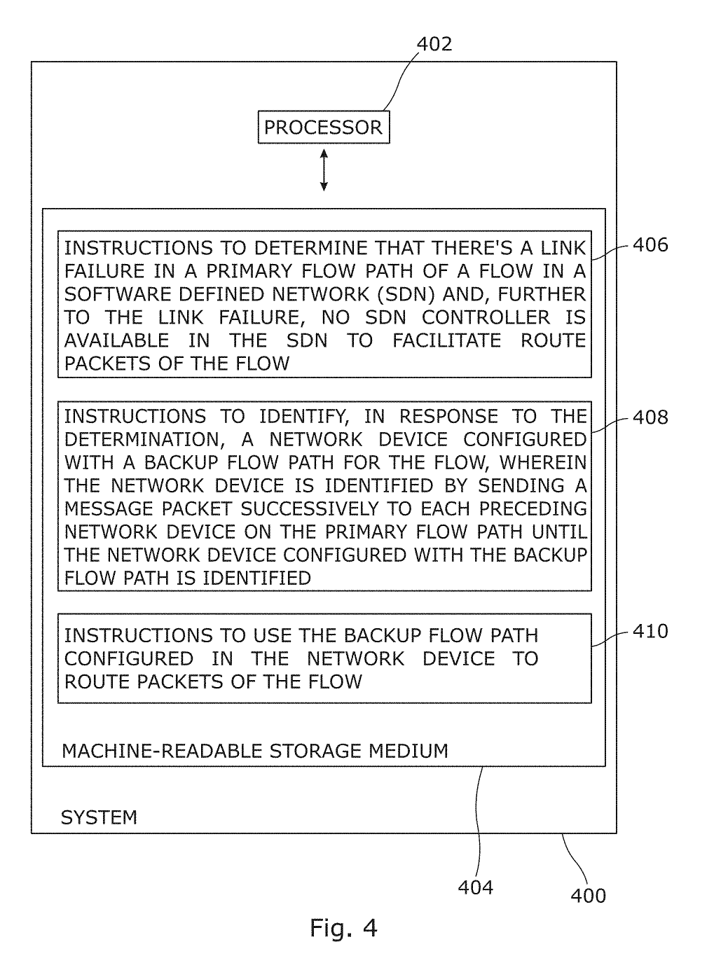

FIG. 4 is a block diagram of an example system 400 for restoring a flow path in response to a link failure in a software defined network (SDN). System 400 includes a processor 402 and a machine-readable storage medium 404 communicatively coupled through a system bus. In an example, system 400 may be analogous to network devices 204, 206, 208, 210, 212, 214, 216, and 218 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 404 may store instructions 406, 408, and 410. In an example, instructions 406 may be executed by processor 402 to determine that there's a link failure in a primary flow path of a flow in a software defined network (SDN) and, further to the link failure, no SDN controller is available in the SDN to facilitate route packets of the flow. Instructions 408 may be executed by processor 402 to identify, in response to the determination (at 406), a network device configured with a backup flow path for the flow, wherein the network device is identified by sending a message packet successively to each preceding network device on the primary flow path until the network device configured with the backup flow path is identified. Instructions 410 may be executed by processor 402 to use the backup flow path configured in the network device to route packets of the flow.

For the purpose of simplicity of explanation, the example method of FIG. 3 is shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method of restoring a flow path in response to a link failure in a software defined network (SDN), comprising:
configuring a backup flow path for a flow, in a network device on a primary flow path of the flow;
in response to determining a link failure in the primary flow path, identifying the network device configured with the backup flow path, wherein the network device is identified by sending, from a detecting network device that detects the link failure on the primary flow path, a message packet successively to each network device preceding the detecting network device on the primary flow path until the network device configured with the backup flow path is identified; and
using the backup flow path to route packets of the flow.

2. The method of claim 1, further comprising configuring a plurality of backup flow paths for the flow in the network device.

3. The method of claim 2, further comprising assigning a priority to each of the plurality of backup flow paths for the flow in the network device.

4. The method of claim 3, further comprising:
determining, among the plurality of backup flow paths for the flow, a backup flow path with highest priority that is available to route packets of the flow; and
using the backup flow path with highest priority to route packets of the flow.

5. The method of claim 1, wherein the backup flow path is configured by a SDN controller prior to the link failure in the primary flow path.

6. A system for restoring a flow path for a flow in response to a link failure in a software defined network (SDN), comprising:
a determination module to determine if there's a link failure in a primary flow path of a flow in a software defined network (SDN);
a backup flow path module to:
identify, in response to the determination that there's a link failure in the primary flow path of the flow, a network device configured with an alternate flow path for the flow, wherein the network device is identified by sending a message packet successively to each preceding network device on the primary flow path until the network device configured with the alternate flow path is identified; and
use the alternate flow path configured in the network device to route packets of the flow.

7. The system of claim 6, wherein the backup flow path module to:
determine that there is a plurality of alternate flow paths for the flow in the network device, wherein each of the plurality of alternate flow paths is assigned a priority;
in response to the determination, determine, among the plurality of alternate flow paths, an alternate flow path with highest priority that is available to route packets of the flow; and
use the alternate flow path with highest priority to route packets of the flow.

8. The system of claim 6, wherein:
the determination module is further to determine that no SDN controller is available in the SDN to facilitate route packets of the flow; and
the backup flow path module to identify, in response to the determination, the network device configured with the alternate flow path for the flow.

9. The system of claim 6, wherein the network device is present on the primary path of the flow.

10. The system of claim 6, wherein the network device is a network switch.

11. A non-transitory machine-readable storage medium comprising instructions to restore a flow path for a flow in response to a link failure in a software defined network (SDN), the instructions executable by a processor to:
determine that there's a link failure in a primary flow path of a flow in a software defined network (SDN) and, further to the link failure, no SDN controller is available in the SDN to facilitate route packets of the flow; and
in response to the determination, identify a network device configured with a backup flow path for the flow, wherein the network device is identified by sending a message packet successively to each preceding network device on the primary flow path until the network device configured with the backup flow path is identified; and
use the backup flow path configured in the network device to route packets of the flow.

12. The storage medium of claim 11, further comprising instructions to:
determine that there is a plurality of backup flow paths for the flow in the network device, wherein each of the plurality of backup flow paths is assigned a priority;
in response to the determination, determine, among the plurality of backup flow paths, a backup flow path with highest priority that is available to route packets of the flow; and
use the backup flow path with highest priority to route packets of the flow.

13. The storage medium of claim 11, wherein the message packet includes information related to identity of the flow and the link failure.

14. The storage medium of claim 13, wherein the message packet is a cookie.

15. The storage medium of claim 11, wherein the backup flow path is configured by the SDN controller prior to becoming unavailable in the SDN.
